(19) United States
(12) Patent Application Publication
(10) Pub. No.: US 2013/0182065 A1
(43) Pub. Date: Jul. 18, 2013

(54) VEHICLE EVENT DATA RECORDER AND ANTI-THEFT ALARM SYSTEM WITH 360 DEGREE PANOGRAPH FUNCTION

(71) Applicant: Shih-Yao CHEN, New Taipei City (TW)

(72) Inventor: Shih-Yao CHEN, New Taipei City (TW)

(21) Appl. No.: 13/351,628

(22) Filed: Jan. 17, 2012

(51) Int. Cl. H04N 7/00

(52) U.S. Cl. 348/36; 348/E07.001

(57) ABSTRACT

A vehicle event data recorder and anti-theft alarm system consisting of a power management system, a 360 degree panoramic lens, a digital data storage unit, a mini display, an operating unit and a wireless communication module is disclosed. When the car is running, the 360 degree panoramic lens picks up images in front of the car for processing through the digital signal processor for enabling the processed image data to be recorded in the digital data storage unit and displayed on the mini display. When the car is parked in a parking place or area, the 360 degree panoramic lens keeps picking up surrounding images, and the digital signal processor immediately actuates an external car anti-theft alarm system/car anti-theft ignition switch cutoff system and drives the wireless communication module to actuate a wireless alarm system in giving off an alarm signal upon occurrence of an abnormal condition.

### BACKGROUND OF THE INVENTION

1. Field of the Invention

The present invention relates to vehicle even data recording technology and more particularly, to a vehicle event data recorder and anti-theft alarm system with 360 degree panograph function, which, in addition to the event data recording function, provides extra anti-theft and alarm functions.

2. Description of the Related Art

For the sake of driving safety, many car owners may install an event data recorder in their cars to record video information related to vehicle crashes or accidents. An event data recorder for this purpose generally comprises one or multiple video cameras and a data storage device for storing image data picked up by the video cameras. An advanced even data recorder may be equipped with a display device for displaying driving images.

However, conventional event data recorders can simply store monitored driving images without other functional designs, not linkable to a car alarm system.

Therefore, there is a strong demand for an improved event data recorder that provides anti-theft and alarm functions.

### SUMMARY OF THE INVENTION

The present invention has been accomplished under the circumstances in view. It is main object of the present invention to provide a vehicle event data recorder and anti-theft alarm system with 360 degree panograph function, which, in addition to the event data recording function, provides extra anti-theft and alarm functions.

To achieve this and other objects of the present invention, a vehicle event data recorder and anti-theft alarm system with 360 degree panograph function is used in a car, comprising: a power management system adapted to obtain electricity from a power supply system of the car; a 360 degree panoramic lens installed in the car for picking up high resolution images; a digital signal processor adapted to receive image signal from the 360 degree panoramic lens and to manipulate received image signal digitally; a digital data storage unit electrically coupled to the digital signal processor for storing digital image data; a mini display electrically coupled to the digital signal processor for image display; an operating unit electrically coupled to the digital signal processor for setting and control; and a wireless communication module electrically coupled to the digital signal processor. When the car is running, the 360 degree panoramic lens picks up images in front of the car for processing through the digital signal processor for enabling the processed image data to be recorded in the digital data storage unit and displayed on the mini display. When the car is parked in a parking place or area, the 360 degree panoramic lens keeps picking up surrounding images for processing by the digital signal processor, and the digital signal processor immediately actuates an external car anti-theft alarm system/car anti-theft ignition switch cutoff system and drives the wireless communication module to actuate a wireless alarm system in giving off an alarm signal upon occurrence of an abnormal condition.

Thus, the vehicle event data recorder and anti-theft alarm system provides, in addition to the image recording function, extra anti-theft and alarm functions, improving the single function design of conventional vehicle event data recorders.

The vehicle event data recorder and anti-theft alarm system further comprises a car stereo head unit installed in the car and connectable to the digital signal processor for displaying images picked up by the 360 degree panoramic lens on a display screen thereof.

The car stereo head unit is electrically coupled to the digital signal processor by wired or wireless method, and adapted to control all system functions of the vehicle event data recorder and anti-theft alarm system and to input parameters into the vehicle event data recorder and anti-theft alarm system.

The vehicle event data recorder and anti-theft alarm system further comprises an infrared transmitter and receiver electrically connected to the digital signal processor, and a remote controller having audio and video transmission functions for communication with the infrared transmitter and receiver for monitoring car internal images and voices.

Further, the remote controller is drivable by the digital signal processor to give off an alarm signal and to display images when the digital signal processor discovers an abnormality during processing of an image signal provided by the 360 degree panoramic lens.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a vehicle event data recorder and anti-theft alarm system with 360 degree panograph function in accordance with the present invention.

### DETAILED DESCRIPTION OF THE PREFERRED EMBODIMENT

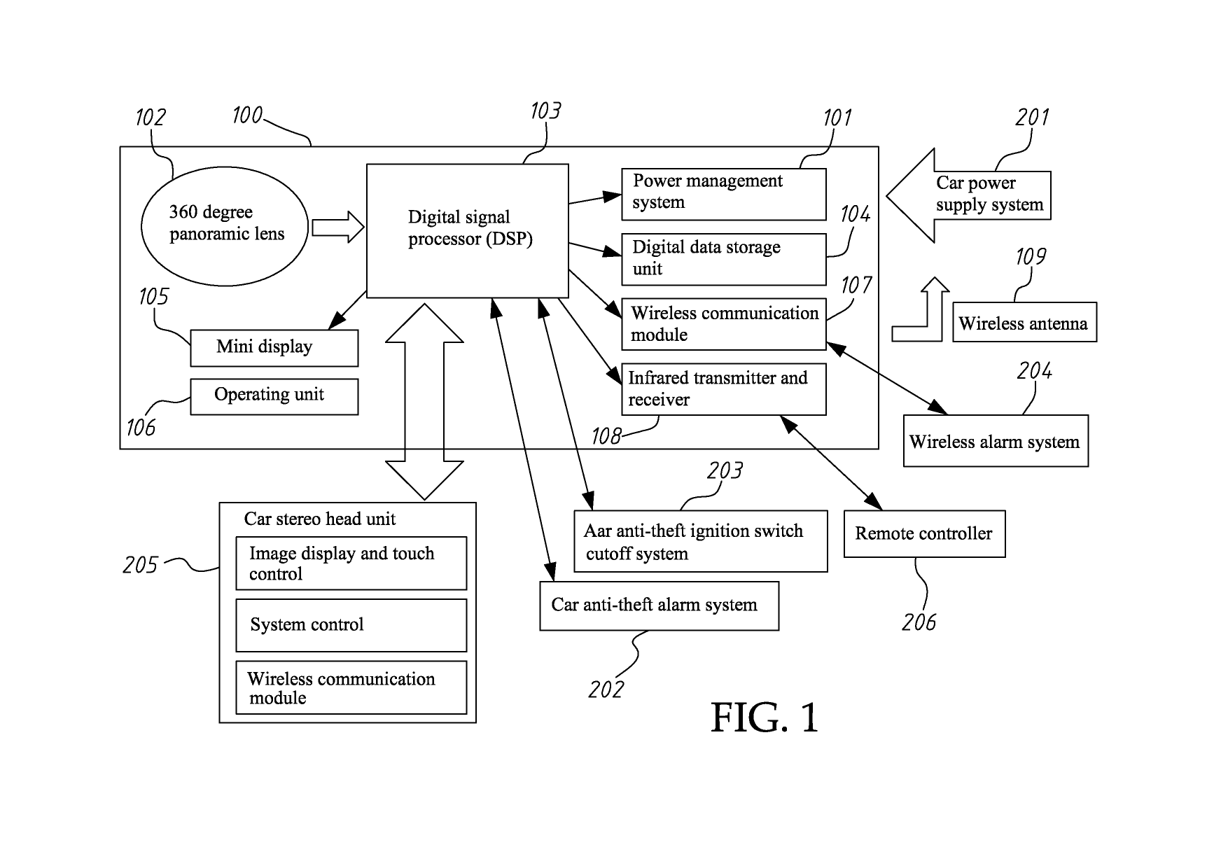

Referring to FIG. 1, a vehicle event data recorder and anti-theft alarm system with 360 degree panograph function in accordance with the present invention is shown. The vehicle event data recorder and anti-theft alarm system 100 comprises a power management system 101, a 360 degree panoramic lens 102, a digital signal processor (DSP) 103, a digital data storage unit 104, a mini display 105, an operating unit 106, and a wireless communication module 107.

The power management system 101 obtains electricity from the power supply system 201 of the car using the vehicle event data recorder and anti-theft alarm system. The 360 degree panoramic lens 102 is installed in the car for picking up high resolution images. The digital signal processor (DSP) 103 is adapted to receive image signal from the 360 degree panoramic lens 102 and to manipulate received image signal digitally. The digital data storage unit 104 is electrically coupled to the digital signal processor (DSP) 103 for storing digital image data. Further, the digital data storage unit 104 can be a SD/USB/HDD peripheral device. The mini display 105 is electrically coupled to the digital signal processor (DSP) 103 for image display. The operating unit 106 is electrically coupled to the digital signal processor (DSP) 103 for setting and control. The wireless communication module 107 is electrically coupled to the digital signal processor (DSP) 103, and has a wireless antenna 109 connected thereto. The wireless communication module 107 can be a RF, Wi-Fi or GPRS module for wireless communication.

When the car is running, the 360 degree panoramic lens 102 picks up images in front of the car. Image signal from the 360 degree panoramic lens 102 is then processed through the digital signal processor (DSP) 103 and then recorded in the digital data storage unit 104 as front event image data, and also displayed on the mini display 105.

After parking of the car in a parking place or area, the 360 degree panoramic lens 102 keeps picking up surrounding images for processing by the digital signal processor (DSP) 103. If any abnormal condition occurs, for example, window breakage, an external object intrusion, or an intrusion of a person into the car, the digital signal processor (DSP) 103 immediately actuates a car anti-theft alarm system 202 or car anti-theft ignition switch cutoff system 203, and/or drives the wireless communication module 107 to actuate a wireless alarm system 204, giving off an alarm signal. The wireless alarms system 204 can be an in-vehicle design, or a remote system.

Further, the vehicle event data recorder and anti-theft alarm system can be electrically coupled with a car stereo head unit 205 in the car. The car stereo head unit 205 provides video display, touch control, system control and wireless communication functions. Thus, the images picked up by the 360 degree panoramic lens 102 can be directly transmitted to the car stereo head unit 205 and displayed on the display screen of the car stereo head unit 205.

The car stereo head unit 205 can be arranged to control the system functions of the vehicle event data recorder and anti-theft alarm system 100 or to input parameters into the vehicle event data recorder and anti-theft alarm system 100 directly or in a wireless manner. Thus, the user can control the vehicle event data recorder and anti-theft alarm system 100 by means of operating the control buttons or touching the touch panel of the car stereo head unit 205. Further, the car stereo head unit 205 can adopt wired communication technology, such as IR, 12C or UART, or wireless communication technology, such as RF, Wi-Fi or GPRS.

The vehicle event data recorder and anti-theft alarm system 100 further comprises an infrared transmitter and receiver 108 electrically connected to the digital signal processor (DSP) 103 for communication with a specific remote controller 206 having audio and video transmission functions. Thus, the infrared transmitter and receiver 108 can transmit car internal images and voices to the remote controller 206. When the digital signal processor (DSP) 103 discovers the occurrence of an abnormal condition from the image signal provided by the 360 degree panoramic lens 102, the remote controller 206 is immediately triggered to give off an alarm signal and to display the images.

In conclusion, the invention provides a vehicle event data recorder and anti-theft alarm system 100, which provides, in addition to the image recording function, extra anti-theft and alarm functions, improving the single function design of conventional vehicle event data recorders.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A vehicle event data recorder and anti-theft alarm system used in a car, comprising:
a power management system adapted to obtain electricity from a power supply system of said car;
a 360 degree panoramic lens installed in said car for picking up high resolution images;
a digital signal processor adapted to receive image signal from said 360 degree panoramic lens and to manipulate received image signal digitally;
a digital data storage unit electrically coupled to said digital signal processor for storing digital image data;
a mini display electrically coupled to said digital signal processor for image display;
an operating unit electrically coupled to said digital signal processor for setting and control; and
a wireless communication module electrically coupled to said digital signal processor;
wherein when said car is running, said 360 degree panoramic lens picks up images in front of said car for processing through said digital signal processor for enabling the processed image data to be recorded in said digital data storage unit and displayed on said mini display; when said car is parked in a parking place or area, said 360 degree panoramic lens keeps picking up surrounding images for processing by said digital signal processor, and said digital signal processor immediately actuates an external car anti-theft alarm system/car anti-theft ignition switch cutoff system and drives said wireless communication module to actuate a wireless alarm system in giving off an alarm signal upon occurrence of an abnormal condition.

2. The vehicle event data recorder and anti-theft alarm system as claimed in claim 1, wherein said digital data storage unit is selected from the group of SD/US/HDD data storage peripheral devices.

3. The vehicle event data recorder and anti-theft alarm system as claimed in claim 1, wherein said wireless communication module is selected from the group of RF, Wi-Fi and GPRS wireless communication systems.

4. The vehicle event data recorder and anti-theft alarm system as claimed in claim 1, wherein said wireless alarm system is an in-vehicle system.

5. The vehicle event data recorder and anti-theft alarm system as claimed in claim 1, wherein said wireless alarm system is an external remote system.

6. The vehicle event data recorder and anti-theft alarm system as claimed in claim 1, further comprising a car stereo head unit installed in said car and connectable to said digital signal processor for displaying images picked up by said 360 degree panoramic lens on a display screen thereof.

7. The vehicle event data recorder and anti-theft alarm system as claimed in claim 6, wherein said car stereo head unit is electrically coupled to said digital signal processor by a wired communication path and adapted to control all system functions of said vehicle event data recorder and anti-theft alarm system to input parameters into said vehicle event data recorder and anti-theft alarm system.

8. The vehicle event data recorder and anti-theft alarm system as claimed in claim 7, wherein said car stereo head unit is electrically coupled to said digital signal processor by a wired communication technology selected from the group of IR, 12C and UART.

9. The vehicle event data recorder and anti-theft alarm system as claimed in claim 6, wherein said car stereo head unit is connected to said digital signal processor by a wireless communication technology and adapted to control all system functions of said vehicle event data recorder and anti-theft alarm system and to input parameters into said vehicle event data recorder and anti-theft alarm system.

10. The vehicle event data recorder and anti-theft alarm system as claimed in claim 9, wherein said wireless communication technology for communication between said car stereo head unit and said digital signal processor is selected from the group of RF, Wi-Fi and GPRS.

11. The vehicle event data recorder and anti-theft alarm system as claimed in claim 1, further comprising an infrared transmitter and receiver electrically connected to said digital signal processor, and a remote controller having audio and video transmission functions for communication with said infrared transmitter and receiver for monitoring car internal images and voices.

12. The vehicle event data recorder and anti-theft alarm system as claimed in claim 1, wherein said remote controller is drivable by said digital signal processor to give off an alarm signal and to display images when said digital signal processor discovers an abnormality during processing of an image signal provided by said 360 degree panoramic lens.
